(19) United States
(12) Patent Application Publication
(10) Pub. No.: US 2011/0117246 A1
(43) Pub. Date: May 19, 2011

(54) COMPOSITION FOR PREPARING IMPROVED GLUTEN-FREE OR GLUTEN-REDUCED BAKERY PRODUCTS

(75) Inventor: Jerome Clement, Carentan (FR)

(73) Assignee: CARGILL, INCORPORATED, Wayzata, MN (US)

(21) Appl. No.: 13/054,513

(22) PCT Filed: Jul. 15, 2009
(86) PCT No.: PCT/EP2009/005140

§ 371 Date: Jan. 17, 2011

(30) Foreign Application Priority Data
Jul. 17, 2008 (EP) 08012956.2

(51) Int. Cl. A21D 13/06; A21D 10/00

(52) U.S. Cl. 426/62; 426/61; 426/549

(57) ABSTRACT

The present invention relates to a composition for preparing gluten-free or gluten-reduced bakery products, comprising enzyme active soy flour and at least one hydrocolloid, as well as a kit of a plurality of ingredients for preparing gluten-free or gluten-reduced bakery products, comprising said enzyme active soy flour and said at least one hydrocolloid. The present invention further relates to a dough comprising said composition, and to a gluten-free or gluten-reduced bakery product, in particular bread or a bread product, produced using said composition. In addition, the present invention relates to the use of enzyme active soy flour or a combination of enzyme active soy flour and at least one hydrocolloid in the preparation of a gluten-free or gluten-reduced, preferably gluten-free, bakery product.

### FIELD OF THE INVENTION

The present invention relates to a composition for preparing gluten-free or gluten-reduced bakery products, comprising enzyme active soy flour and at least one hydrocolloid, as well as a kit of a plurality of ingredients for preparing gluten-free or gluten-reduced bakery products, comprising said enzyme active soy flour and said at least one hydrocolloid. The present invention further relates to a dough comprising said composition, and to a gluten-free or gluten-reduced bakery product, in particular bread or a bread product, produced using said composition. In addition, the present invention relates to the use of enzyme active soy flour or a combination of enzyme active soy flour and at least one hydrocolloid in the preparation of a gluten-free or gluten-reduced, preferably gluten-free, bakery product.

### BACKGROUND OF THE INVENTION

Bread is a traditional food generally prepared from wheat flour. This cereal contains two proteins, glutenin and gliadin, which cross-link during mixing and develop into gluten. The development of gluten affects the texture, in particular the viscoelastic behaviour, of the baked goods. Furthermore, the gluten network traps the carbon dioxide gas produced by leavening agents, such as yeast, during the proofing process of doughs, thereby causing the doughs to swell or rise. Baking coagulates the gluten, which, along with starch, stabilizes and retains the gas cells of the final baked product (Gan et al., J. Cereal. Sci. 10: 81-91 (1989)).

Although important for the making of baked goods, in particular bread, the presence of gluten can cause health problems in predisposed individuals, and is avoided in the diet of coeliac disease patients. Coeliac disease is a life-long autoimmune disease of the small intestine caused by a reaction to the gliadin fraction of wheat and the prolamins of rye (secalins), barley (hordeins) and possibly oats (avidins) (Murray, J. A., Am. J. Clin. Nutr. 69: 354-365 (1999)) and is estimated to affect about 1% of all Indo-European populations. This condition is characterized by a damage to the mucous membrane of the small intestine, which results in poor absorption of nutrients and, consequently, weight loss, diarrhea, anemia, fatigue, flatulence, deficiency of folate, and osteopenia (Blades, M., Nutr. Food Sci. 4: 146-151 (1997); Thompson, T., J. Am. Diet. Assoc. 1000: 1389-1396 (2000)). The only effective treatment for coeliac disease is to strictly avoid any gluten-containing products, in particular product that contain wheat, rye or barley, which leads to a reduction in symptoms and significant improvement in both the condition of the intestinal mucosa and its absorptive function (Gallagher et al., Trends Food Sci. Technol. 15: 143-152 (2004)). The exclusion of gluten consumption, however, is not easy for coeliac patients because gluten-containing products include some of the most common foods, such as breads, cakes, biscuits, pizzas, pasta, etc.

Since gluten contributes to the appearance and crumb structure of bread, its replacement is a critical and difficult task for the food chemist. Indeed, many of the gluten-free products currently available on the market are of low or at least unsatisfactory quality, demonstrating poor mouthfeel, fast crumb hardening, low specific bread volume, short shelf-lives and poor sensory attributes (see, e.g., Arendt et al., Farm Food 12: 21-27 (2002)). In order to produce gluten-free breads of improved quality, a large number of flours, starches and many other substances, such as enzymes, proteins and hydrocolloids, have been applied to mimic the viscoelastic properties of gluten (Gujral, H. S. & Rosell, C. M., Food Res. Int. 37: 75-81 (2004); Kim, J. & De Ruiter, D., Food Technol. 22: 867-878 (1968); Sanchez et al., Food Sci. Technol. Int. 10: 5-9 (2004); Toufeili et al., Cereal Chem. 71: 594-601 (1994)).

Hydrocolloids are polysaccharides of high molecular weight extracted from plants and seaweeds or produced by microbial synthesis, which are widely used in the food industry for numerous applications, for example as texturizing agents (Diezak, J. D., Food Technol. 45: 116-132 (1991)). In the bakery industry, hydrocolloids, such as hydroxypropyl methyl cellulose (HPMC) and xanthan gum, have been used as gluten-substitute to improve certain properties of gluten-free bread. For example, the use of HPMC resulted in breads with higher specific bread volume and improved sensory characteristics (Bárcenas & Rosell, Food Hydrocoll. 19: 1037-1043 (2005)).

However, the currently marketed gluten-free breads are still associated with drawbacks compared to the corresponding standard wheat products. For example, many of these gluten-free breads have an insufficient and/or irregular porous cell structure and/or a low bread volume. Others are unsatisfactory with respect to sensory attributes. Moreover, many gluten-free breads suffer from a high loss of moisture content during storage, resulting in bread hardening (“crumb” hardening).

In fact, many commercial gluten-free breads are definitely firm after few hours of storage. After prolonged storage, cracks in the bread loafs frequently appear. This is attributed to the retrogradation of the starches, which substitute wheat flour in these gluten-free breads, in combination with loss of water. As a result, such breads do not keep softness and freshness for sufficiently long periods of time and throughout their entire shelf-life.

Thus, in view of the growing numbers of individuals affected with coeliac disease, there is an increasing need for novel, nutritious and high-quality gluten free food products.

This need is met by the present invention, which is based on the unexpected finding that the employment of a combination of enzyme active soy flour and at least one hydrocolloid results in gluten-free breads, which have uniform and well distributed cells as well as favourable and high specific bread volumes. In addition, the combination of enzyme active soy flour and at least one hydrocolloid was unexpectedly found to decrease the loss of moisture content during storage, which positively decreased crumb hardening without negatively affecting the moisture content. As a consequence, the gluten-free breads containing enzyme active soy flour and at least one hydrocolloid were found to stay soft and fresh for extended periods of time, thereby retaining their desirable soft texture for the shelf-life of these gluten-free breads. Moreover, the use of a combination of enzyme active soy flour and at least one hydrocolloid allowed to achieve further desirable characteristics, such as a desirable shape and appearance as well as improved sensory characteristics, like a pleasant mouthfeel and flavour.

### SUMMARY OF THE INVENTION

In a first aspect of the present invention, there is provided a composition for preparing gluten-free or gluten-reduced bakery products, comprising enzyme active soy flour and at least one hydrocolloid.

In a second aspect of the present invention, there is provided a kit of a plurality of ingredients for preparing gluten-free or gluten-reduced bakery products, wherein the ingredients include enzyme active soy flour and at least one hydrocolloid.

In a third aspect of the present invention, there is provided a dough for preparing a gluten-free or gluten-reduced bakery product, comprising the composition for preparing gluten-free or gluten-reduced bakery products as described herein above together with one or more gluten-free native or modified starches or gluten-free flours and a liquid in appropriate amounts to form a dough.

In a fourth aspect of the present invention, there is provided a gluten-free or gluten-reduced bakery product produced using the composition, the kit or the dough described herein above. Preferably, the bakery product of the present invention is gluten-free.

In a fifth aspect, the present invention relates to the use of enzyme active soy flour or a combination of enzyme active soy flour and at least one hydrocolloid in the preparation of the gluten-free or gluten-reduced bakery product.

In a last aspect, the present invention relates to the use of a composition of the present invention, comprising enzyme active soy flour and at least one hydrocolloid, in the preparation of a gluten-free or gluten-reduced bakery product.

### DETAILED DESCRIPTION

In a first aspect of the present invention, there is provided a composition for preparing gluten-free or gluten-reduced bakery products, comprising enzyme active soy flour and at least one hydrocolloid.

An enzyme active soy flour suited for use herein is any soy flour (soybean flour) that contains lipoxygenase activity. Hydrocolloids that may be present in the composition of the present invention include, but are not limited to, alginate, carrageenan, guar gum, locust bean gum, pectin, scleroglucan, xanthan gum, carboxymethyl cellulose, methyl cellulose, hydroxypropyl methyl cellulose, and mixtures thereof. Particularly preferred are xanthan gum and guar gum, and most preferred is a mixture of xanthan gum and guar gum.

The term “bakery products”, as used herein, is intended to mean any product produced and/or sold by a bakery and includes in particular bread and bread products, pies, pastries, cakes, biscuits, cookies, etc. In particular, the term “bakery product” refers to breads and cakes, and especially to breads and breadcrumbs made from these breads.

The weight ratio of enzyme active soy flour to the at least one hydrocolloid in the composition of the present invention ranges from 0.33 to 150, preferably from 0.5 to 50, more preferably from 5 to 20, and most preferably from 5 to 10.

In a preferred embodiment, the composition may further comprise one or more gluten-free native or modified starches or gluten-free flours. Examples of suitable gluten-free starches or flours include, but are not limited to, wheat starch (gluten-free or essentially gluten-free), rice starch and flour, corn starch and flour, potato starch and flour, cassaya starch and flour, soy bean starch and flour, arrowroot starch and flour, tapioca starch and flour, buckwheat starch and flour, sorghum starch and flour, and any combination thereof. Preferred examples include corn starch and flour, potato starch and flour and rice starch and flour. In another embodiment, it is contemplated that the composition of the present invention exclusively consists of enzyme active soy flour and at least one hydrocolloid.

It was unexpectedly found that the use of one or more modified starches increases the freshness of bakery products like breads. It was also unexpectedly found that the use of different native starches allows to make the bakery product recipe, in particular a bread recipe, more tolerant to the production process, for example desirable and nice bread shapes were obtained irrespective of the oven used. Thus, in an especially preferred embodiment, the composition of the present invention may comprise one or more modified starches and/or a mixture of different native starches. Particularly suitable modified starches for use herein are one or more hydroxypropylated starches, such as hydroxypropyl distarch phosphate (in particular those with a medium level of cross-linking) and hydroxypropyl starch. These modified starches may be from any origin, but are preferably from tapioca. Most preferably, a combination of hydroxypropyl distarch phosphate and hydroxypropyl starch is used herein. A preferred mixture of different native starches for use herein is a combination of native corn starch and potato starch, wherein the ratio of these native starches is preferably in the range of 3:1 to 15:1.

Furthermore, the composition of the present invention may contain one or more additional ingredients including, but not limited to, leavening agents (e.g. yeast or baking powder), sugar (e.g. glucose, fructose, glucose or fructose syrup, etc.), salt, emulsifiers (e.g. SSL (sodium stearoyl-2-lactylate), DATA-esters, monoglycerides), oxidizing and reducing agents (e.g. ascorbic acid, cysteine), enzymes (e.g. α-amylase, hemicellulase), microbial inhibitors (e.g. calcium propionate and potassium sorbate), binding agents, (e.g. pre-gelatinized starch), glycerol, oils (e.g. vegetable oil, such as palm oil, canola oil, corn oil, soybean oil, sunflower seed oil, safflower oil, rapeseed oil, cottonseed oil, olive oil, sesam oil), water, milk, eggs, flavoring agents (e.g. vanilla), cacao powder, and the like.

Preferably, the composition of the present invention contains exclusively gluten-free ingredients, i.e. in particular gluten-free starches and flours. However, the present invention also contemplates compositions, which comprise a certain, usually low amount, of gluten-containing ingredients, such as wheat flour, resulting in a composition that may be used for making a gluten-reduced bakery product, such as a gluten-reduced bread or cake.

In a second aspect of the present invention, there is provided a kit of a plurality of ingredients for preparing gluten-free or gluten-reduced bakery products, wherein the ingredients include enzyme active soy flour and at least one hydrocolloid.

The enzyme active soy flour and the at least one hydrocolloid are as defined herein above. Further ingredients, such as the gluten-free native or modified starches or gluten-free flours and one or more of the additional ingredients mentioned herein above, may also be included in the kit. The plurality of ingredients included in the kit may be present isolated from each other and/or in admixture of two or more of the ingredients. Preferably, all ingredients of the kit are gluten-free.

In a third aspect of the present invention, there is provided a dough for preparing a gluten-free or gluten-reduced bakery product, comprising the composition for preparing gluten-free or gluten-reduced bakery products as described herein above together with one or more gluten-free native or modified starches or gluten-free flours and a liquid in appropriate amounts to form a dough.

A “dough” with the meaning of the present invention includes any paste made by mixing the combination of enzyme active soy flour and at least one hydrocolloid with at least one gluten-free starch or flour and a liquid, and, optionally, one or more of the additional ingredients mentioned herein above in appropriate amounts to form a precursor of bakery products having a cohesive consistency.

Suitable gluten-free native or modified starches or gluten-free flours include those defined herein above. Preferably, the dough includes one or more hydroxypropylated starches, in particular a combination of hydroxypropyl distarch phosphate and hydroxypropyl starch, and/or different native starches like a combination of native corn starch and potato starch. The liquid is preferably water and may include other liquid substances, such as milk, eggs, oils, and the like. Preferably, the dough contains a leavening agent. The leavening agent is preferably yeast. However, other leavening agent, such as baking powder (a mixture of tartaric acid and bicarbonate of soda) and baking soda (sodium bicarbonate) may also be used.

In a preferred embodiment of the present invention, the enzyme active soy flour is present in the dough in an amount of 1 to 15 wt. %, preferably 1 to 10 wt. %, and the at least one hydrocolloid is present in the dough in an amount of 0.1 to 3.0 wt. %, preferably 0.2 to 2.0 wt. %, based on the total dough weight. The starch and/or flour is usually present in an amount of between about 20 and 80 wt. %, more preferably between about 25 and 60 wt. %, and even more preferably between about 30 and 55 wt. %, based on the total dough weight.

The dough can be prepared by mixing the dough ingredients using conventional equipment and procedures know to a person skilled in the art. If yeast is employed in the dough formulation of the bakery product, a fermentation or proofing step is included in the dough preparation. During proofing the yeast converts glucose and other carbohydrates to produce carbon dioxide gas, which stretches and rises the dough, thereby imparting a favourable texture to the final baked product.

Of course, the dough formulations may also contain conventional bread ingredients normally used in the baking industry to provide flavouring, coloring, texturizing, and the like as long as they do not adversely effect the properties of the resulting baked products, such as shelf-life or sensory attributes. In particular, the dough formulation of the present invention may contain any one of the ingredients described above in conjunction with the composition of the present invention for preparing gluten-free or gluten-reduced bakery products. Thus, the dough of the present invention can be used to prepare various bakery products, in particular a wide variety of bread, bread products and cakes. Moreover, the dough of the present invention may contain, for example, cheese, herbs and spices, fruits, vegetables, encapsulated flavour and/or aroma ingredients, and the like. Preferably, all ingredients of the dough of the present invention are gluten-free.

Since gluten-free breads and other gluten-free food products, such as cakes and the like, tend to have a lower protein content than the corresponding standard food products, the present invention also contemplates for adding ingredients that increase the protein level in gluten-free bakery products. The use of soybean flour, as described herein, is already a positive way to improve the protein levels. Other ingredients, which may be used as an effective ingredient to increase protein contents, include, for example, flours that contain non-gluten proteins in a significant amount or any other protein containing additive as long as the properties of the final product are not adversely affected. As an example, carob germ flour, which has a viscoelastic behaviour close to vital wheat gluten, allows increasing proteins level in gluten-free bakery products, thereby enhancing their nutritional profile.

In addition, in view of the fact that individuals suffering from coeliac disease often have a low intake of fibers due to their gluten-free diet, the present invention also contemplates the incorporation of dietary fibers in gluten-free bakery products to produce high nutritious gluten-free products. The dietary fibers may, for example, be supplemented in the form of alternative gluten-free flours or as isolated dietary fibers, as known in the art.

In a fourth aspect of the present invention, there is provided a gluten-free or gluten-reduced bakery product produced using the composition, the kit or the dough described herein above. Preferably, the bakery product of the present invention is gluten-free.

The process for preparing a gluten-free or gluten-reduced bakery product comprises mixing the respective ingredients together in relative amounts sufficient to form a coherent dough, optionally allowing the dough to stay or proofing the dough, and heating the dough for a time and at a temperature sufficient to produce the bakery products, as known in the art.

In a fifth aspect, the present invention relates to the use of enzyme active soy flour or a combination of enzyme active soy flour and at least one hydrocolloid in the preparation of the gluten-free or gluten-reduced bakery product.

In a last aspect, the present invention relates to the use of a composition of the present invention, comprising enzyme active soy flour and at least one hydrocolloid, in the preparation of a gluten-free or gluten-reduced bakery product.

The present invention will now be further illustrated by reference to the following examples and figures, in which:

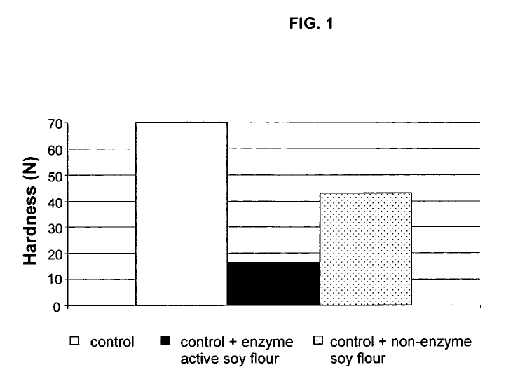

FIG. 1 shows the hardness of a bread produced according to a standard recipe (“control”) in comparison to breads produced using the same standard recipe except that 20% of potato starch have been substituted by toasted (non-enzymatic) soy flour (“control+non-enzyme soy flour”) and enzyme active soy flour (“control+enzyme active soy flour”), respectively, and

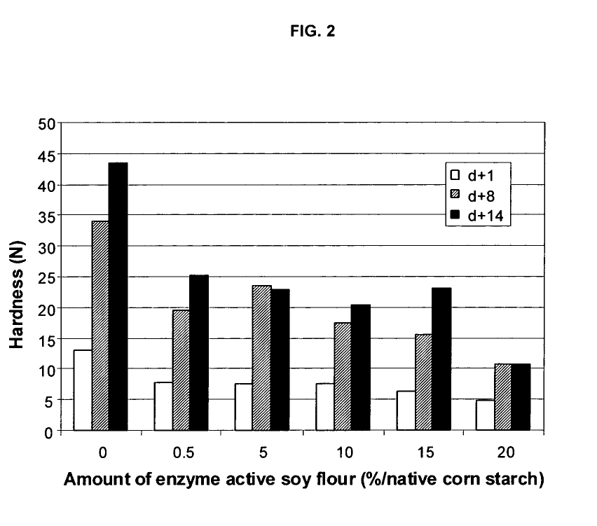

FIG. 2 shows the hardness of breads with varying amounts of active enzyme soy flour after storage for 1, 8 and 14 days.

### EXAMPLES

Commercial sources for the food grade polymers used in all experiments are as follows:
(1) native corn starches sold under the trade names C*Gel 03401 by Cargill, Sas Van Gent, the Netherlands and C*Gel 03402 by Cargill, Krefeld, Germany;
(2) modified starch sold under the trade name C*EmTex 12688 by Cargill, Sas Van Gent, the Netherlands, and hydroxypropyl distarch phosphate (tapioca origin) sold under the trade name C*Cream Tex 75710 and hydroxypropyl starch (tapioca origin) sold under the trade name C*Cream Tex 75753 by Cargill;
(3) enzyme active soy flour sold under the trade names Profull 68131 and 68137 and toasted soy flour sold under the trade name Profull 68141 by Cargill, Gent, Belgium;
(4) xanthan/guar mixture sold under the trade name Lygomme MM391, xanthan gum sold under the trade name Satiaxane CX90 by Cargill, Baupte, France, and guar gum sold under the trade name Viscogum MP41230 by Cargill;
(5) glucose/fructose syrup sold under the trade name C*Sweet F01701 by Cargill, Sas Van Gent, the Netherlands;
(6) maltodextrins sold under the trade name C*Dry MP 01910 by Cargill, Haubourdin, France; and
(7) dextrose sold under the trade name C*Dex 02043 by Cargill.

### Example 1

### Effect of Enzyme Active Soy Flour in a Gluten-Free Bread

This example illustrates the effect of partially substituting native corn starch of a gluten-free bread by enzyme active soy flour and toasted (non-enzyme) soy flour. First, a control dough was made using a recipe for a gluten-free bread. Further, two sample doughs were made using the same recipe, except that 20 wt. % of native corn starch was replaced by enzyme active soy flour or toasted (non-enzyme) soy flour, respectively. The formulations used to prepare the control dough and the two sample doughs are shown in Table 1.

TABLE 1
Formulations of control dough and soy flour doughs.

| | AMOUNTS (g) of | | |
|---|---|---|---|
| | | Enzyme Active | Toasted (Non- |
| | | Soy Flour | Enzyme) Soy |
| INGREDIENTS | Control Dough | Dough | Flour Dough |
| C*Gel 03401 (native corn starch) | 100 | 80 | 80 |
| ProFull 68131 (enzyme active soy flour) | | 20 | |
| Profull 68141 (toasted soy flour) | | | 20 |
| Lygomme MM391 (xanthan/guar) | 2 | 2 | 2 |
| Rice flour | 11 | 11 | 11 |
| Salt | 2.2 | 2.2 | 2.2 |
| Sugar | 8 | 8 | 8 |
| Oil | 5 | 5 | 5 |
| Yeast | 8 | 8 | 8 |
| Water | 120 | 120 | 120 |

The dry ingredients except the yeast were mixed for 1 min on setting 1 (low speed) using a mixer. The oil, the liquid and yeast predispersed in a part of water were added to the dry ingredients. The resulting mixture was mixed for 2 min on setting 1, then for 1 min on setting 6 (medium speed). Batter was then scraped down from the sides of the bowl, and the batter was mixed for 1 additional min on setting 6. Approximately 250 g of batter were poured into each open pan. The batter was then proofed for 1 h at 22° C. The batter was then baked in a conventional air pulsed oven at 160° C. for 30 min.

After storage for 7 days at a temperature of about 20° C. and relative humidity of around 60% in sealed polyamide/polyethylene plastic bags the hardness (firmness) of the obtained bread loaves were evaluated by texture analysis to investigate the impact of the enzyme active soy flour or toasted (non-enzyme) soy flour, respectively. The texture profile Analysis TPA° was performed in a TAXT2i (Stable Micro Systems, Surrey, UK). A 50 mm diameter plunger at a crosshead speed of 0.8 mm/s compressed a 20 mm thick slice to a depth of 30%. The height of the first compression curve measured the resistance of the crumb to the penetrating plunger and represented the crumb hardness.

As can be seen from FIG. 1, the control dough resulted in a bread having a hardness of 70 N. The same recipe having 20% of the native corn starch substituted by toasted (non-enzyme active) soy flour yielded a bread having a moderately reduced hardness of 43 N. The use of enzyme active soy flour led to a bread having a significantly decreased hardness of 16 N. Thus, enzyme active soy flour positively decreased crumb hardening of industrial gluten-free bread during storage.

### Example 2

### Appropriate Amounts of Enzyme Active Soy Flour and Hydrocolloids

In this Example the appropriate amounts of enzyme active soy flour and hydrocolloids to obtain a high-quality, gluten-free bread were evaluated.

### A. Enzyme Active Soy Flour

In order to determine the optimal level of use of enzyme active soy flour, gluten-free breads with 0 wt. %, 0.5 wt. %, 5 wt. %, 10 wt. %, 15 wt. % and 20 wt. % enzyme active soy flour, based on the weight of native corn starch, were prepared by introducing the appropriate amounts of enzyme active soy flour in the following recipe in substitution of native corn starch (see Table 2).

TABLE 2
Recipe used for the studies.

| INGREDIENTS | PREPARED DOUGHS (in g) |
|---|---|
| C*Gel 03401 (native corn starch) | from 35.2 to 42.2 (control) |
| ProFull 68131 (enzyme active soy flour) | from 0 (control) to 7 |
| Lygomme MM391 (xanthan/guar) | 1.1 |
| Water | 48.2 |
| Yeast | 2.9 |
| C*Sweet F01701 (glucose/fructose syrup) | 1.8 |
| Sugar | 1.2 |
| Glycerol | 0.9 |
| Rapeseed oil | 0.8 |
| Salt | 0.7 |
| Calcium propionate | 0.2 |
| Emulsifier (sodium steoaryl lactylate) | 0.1 |
| TOTAL | 100 |

Batters and breads were prepared as described in Example 1. The hardness of the resulting gluten-free breads upon storage for 1, 8, and 14 days was assessed as described in Example 1.

As can be seen from FIG. 2, active enzyme soy flour improved crumb softness even at concentrations as low as 0.5 wt. % of the total weight of the used native corn starch. The best results, however, are obtained at higher concentrations, wherein the lowest hardness value was achieved at 20 wt. % of active enzyme soy flour. However, above 20 wt. % of active enzyme soy flour (about 7 wt. % of the total weight of the formulation), unpleasant off-flavors of beans become increasingly strong.

It is to be noted that the measured ability of active enzyme soy flour to improve crumb softness was not observed using other enzyme active flours. The use of malted barley, for example, created a big hole in the bread, and the use of bean flour provided cracks on bread crumbs (results not shown). Further, a DSC analysis of three different gluten-free breads (starch based only, with toasted soy flour, and with enzyme active soy flour) with respect to the impact of enzyme active soy flour on starch behaviour indicated that enzyme active soy flour, and to a lesser extent also toasted soy flour, slows down retrogradation, the cause of ordinary texture staling of the crumb (increased hardness). However, the difference in texture between soy flour breads (toasted vs. non-toasted) could not yet be explained by DSC. Without being bound to theory, it is believed that the observed favourable effect on bread quality of the enzyme active soy flour compared to toasted (non-enzyme) soy flour may be due to the enzymes contained in the enzyme active soy flour.

### B. Hydrocolloids

Doughs prepared using the industrial formulation of Example 1, but without hydrocolloids (xanthan/guar gum mixture), were found to have a reduced batter viscosity. The final bread showed a poor volume with essentially no crumb alveolation (results not shown), demonstrating that hydrocolloid(s), e.g. the mixture of xanthan gum and guar gum used in this example, are required to achieve a pleasant shape and regular crumb alveolation. The optimal dosage can readily be determined by an averaged skilled person by means of routine experimentation.

### Example 3

### Recipe of a Gluten-Free Bread According to the Present Invention with Improved Volume, Texture and Softness

This example illustrates an exemplary, optimized formulation for making gluten-free bread having a desirable shape and volume, which keep softness and freshness over extended time periods.

An optimization of the enzyme active soy flour containing gluten-free bread formulation of Example 1 resulted in the final formulation shown in Table 3.

TABLE 3
Formulation of a gluten-free bread of the present invention.

| | AMOUNTS | %/ | %/ |
|---|---|---|---|
| INGREDIENT | (g) | TOTAL | STARCH |
| C*Gel 03401 (native corn | 600.0 | 35.2 | 100.0 |
| starch) | | | |
| Profull 68131 (enzyme active | 120.0 | 7.0 | 20.0 |
| soy flour) | | | |
| Lygomme MM391 (xanthan/ | 12.4 | 1.1 | 3.0 |
| guar) | | | |
| Salt | 12.0 | 0.7 | 2.0 |
| Sugar | 20.0 | 1.2 | 3.3 |
| Glycerol | 15.0 | 0.9 | 2.5 |
| Emulsifier (sodium steoaryl | 1.0 | 0.1 | 0.2 |
| lactylate) | | | |
| Calcium propionate | 4.0 | 0.2 | 0.7 |
| C*Sweet F01701 (glucose/ | 30.0 | 1.8 | 5.0 |
| fructose syrup) | | | |
| Rape oil | 14.0 | 0.8 | 2.3 |
| Yeast | 50.0 | 2.9 | 8.3 |
| Water 1 | 100.0 | 5.9 | 16.7 |
| Water 2 | 720.0 | 42.3 | 120.0 |
| TOTAL | 1698.4 | 100.0 | 284.0 |

This formulation allows the production of gluten-free breads of high quality having a desirable shape and specific volume, a regular crumb alveolation, an improved crumb softness, a decreased tendency to crumble, and an improved crumb mouthfeel.

### Example 4

### Recipe of a Gluten-Free Bread According to the Present Invention with Improved Shape and Volume, Texture, Softness, and Freshness During Storage

This example illustrates another exemplary, optimized formulation for making gluten-free bread having an improved shape, freshness and mouthfeel.

The recipe of Example 3 was modified to give the improved final bread formulation shown in Table 4.

TABLE 4
Formulation of another gluten-free bread of the present invention.

| | AMOUNTS | %/ | %/ |
|---|---|---|---|
| INGREDIENT | (g) | TOTAL | STARCH |
| C*Gel 03402 (native corn | 620 | 31.0 | 100.0 |
| starch) | | | |
| C*Cream Tex 75710 | 28 | 1.4 | 4.5 |
| (hydroxypropyl distarch | | | |
| phosphate) | | | |
| C*Cream Tex 75753 | 44 | 2.2 | 7.1 |
| (hydroxypropyl starch) | | | |
| Profull 68131 (enzyme active | 138 | 6.9 | 22.2 |
| soy flour) | | | |
| Satiaxane CX90 (xanthan gum) | 10 | 0.5 | 1.5 |
| Viscogum MP41230 (guar gum) | 2 | 0.1 | 0.3 |
| Salt | 14 | 0.7 | 2.2 |
| C*Dex 02043 (dextrose) | 22 | 1.1 | 3.7 |
| Glycerol | 18 | 0.9 | 2.8 |
| Emulsifier (sodium steoaryl | 2 | 0.1 | 0.2 |
| lactylate) | | | |
| Calcium propionate | 4 | 0.2 | 0.7 |
| C*Sweet F01701 (glucose/ | 34 | 1.7 | 5.6 |
| fructose syrup) | | | |
| Rape oil | 48 | 2.4 | 7.9 |
| Vanilla | 28 | 1.4 | 4.6 |
| Yeast | 76 | 3.8 | 12.3 |
| Water 1 | 154 | 7.7 | 24.8 |
| Water 2 | 758 | 37.9 | 122.3 |
| TOTAL | 2000 | 100.0 | 322.7 |

This formulation allows the production of gluten-free breads of high quality having a desirable shape and specific volume, an improved crumb softness, a decreased tendency to crumble, an improved crumb mouthfeel and, in particular, a significantly improved freshness of the finished bread during storage compared to the bread obtained with the recipe of Example 3.

In follow-up experiments, it was further found that the use of different native starches, for example corn starch and potato starch, makes the recipe more tolerant to the process, i.e. desirable and nice bread shapes were obtained whatever the type of oven used.

The main ingredients, which are responsible for the quality improvement, are enzyme active soy flour and one or more hydrocolloids, like the mixture of xanthan gum and guar gum used in Example 3 or the mixture of xanthan gum, guar gum and modified starch used in this example. A person skilled in the art will appreciate that other hydrocolloids, either alone or in combination, or other starches or flours may be used to obtain a bread with desirable properties.

1. A composition for preparing gluten-free or gluten-reduced bakery products, comprising enzyme active soy flour and at least one hydrocolloid.

2. The composition of claim 1, wherein the hydrocolloid is selected from the group consisting of alginate, carrageenan, guar gum, locust bean gum, pectin, scleroglucan, xanthan gum, carboxymethyl cellulose, methyl cellulose, hydroxypropyl methyl cellulose, and mixtures thereof.

3. The composition of claim 2, wherein the hydrocolloid is selected from xanthan gum, guar gum and mixtures thereof.

4. The composition of claim 1, wherein the weight ratio of enzyme active soy flour to the at least one hydrocolloid is from 0.5 to 50.

5. The composition of claim 4, wherein the weight ratio of enzyme active soy flour to the at least one hydrocolloid is from 5 to 20.

6. The composition claim 1, further comprising one or more gluten-free native or modified starch or gluten-free flour.

7. A kit of a plurality of ingredients for preparing gluten-free or gluten-reduced bakery products, wherein the ingredients include enzyme active soy flour and at least one hydrocolloid.

8. A dough for preparing a gluten-free or gluten-reduced bakery product, comprising the composition of claim 1 together with one or more gluten-free starches or flours and a liquid in appropriate amounts sufficient to form a dough.

9. The dough of claim 8, wherein the amount of the enzyme active soy flour is from 1 to 10 wt. % and the amount of the at least one hydrocolloid is from 0.2 to 2.0 wt. %, based on the total dough weight.

10. The dough of claim 8, further comprising yeast.

11. A gluten-free or gluten-reduced bakery product produced using the composition of claim 1.

12-15. (canceled)

16. A gluten-free or gluten-reduced bakery product produced using the kit of claim 7.

17. A gluten-free or gluten-reduced bakery product produced using the dough of claim 8.

18. The composition of claim 1, wherein the composition is gluten-free.

19. The kit of claim 7, wherein the kit is gluten-free.

20. The dough of claim 8, wherein the dough is gluten-free.

21. The composition of claim 1, wherein the gluten-free or gluten-reduced bakery product is a bread or bread product.

22. The kit of claim 7, wherein the gluten-free or gluten-reduced bakery product is a bread or bread product.

23. The dough of claim 8, wherein the gluten-free or gluten-reduced bakery product is a bread or bread product.

24. The gluten-free or gluten-reduced bakery product of claim 11, wherein the gluten-free or gluten-reduced bakery product is a bread or bread product.

25. The gluten-free or gluten-reduced bakery product of claim 16, wherein the gluten-free or gluten-reduced bakery product is a bread or bread product.

26. The gluten-free or gluten-reduced bakery product of claim 17, wherein the gluten-free or gluten-reduced bakery product is a bread or bread product.
